(19) United States
(12) Patent Application Publication
(10) Pub. No.: US 2010/0025953 A1
(43) Pub. Date: Feb. 4, 2010

(54) RIGID AXLE FOR A UTILITY VEHICLE

(75) Inventors: Manfred Buhl, Bissendorf (DE); Soren Knopp, Ostercappeln (DE); Friedheim Langhorst, Diepholz (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/526,839

(22) PCT Filed: Feb. 4, 2008
(86) PCT No.: PCT/DE08/00193

§ 371 Date: Aug. 12, 2009

(30) Foreign Application Priority Data
Feb. 16, 2007 (DE) 10 2007 008 325.6

(51) Int. Cl. B60G 9/02; B60G 7/00

(52) U.S. Cl. 280/124.111; 280/124.153

(57) ABSTRACT

A rigid axle for a commercial vehicle having individual first and second suspension struts (1, 2) which define a triangle in a common plane. Each end of these struts have a joint (3, 4, 5, 6) to connect one end of the struts to the automotive body (7) and the other end of the struts to the vehicle axle (8). The end of the struts that is connected to the axle receives an axial pin (9) for connecting the suspension struts (1, 2) to the vehicle axle (8).

This application is a National Stage completion of PCT/DE2008/000193 filed Feb. 4, 2008, which claims priority from German patent application Ser. No. 10 2007 008 325.6 filed Feb. 16, 2007.

### FIELD OF THE INVENTION

The invention relates to a rigid axle for a commercial vehicle.

### BACKGROUND OF THE INVENTION

Representative rigid axles for commercial vehicles with two individual suspension struts that in the neutral positions thereof define a triangle in a common plane, at the ends of which a joint each being connected to the automotive body and to the vehicle axle, are known, for example, from DE 43 38 651 A1, DE 101 18 623 A1, or U.S. Pat. No. 5,458,359. In addition, DE 103 48 645 A1 discloses a suspension strut, which on the one side has an axial joint, the connecting pin of which is oriented coaxially to the longitudinal center line of the suspension strut. On the side opposite the axial joint, this suspension strut has a molecular joint or a molecular bearing. The terms molecular bearing and molecular joint in this context should be interpreted as being synonymous. Such molecular joints, or molecular bearings, have a pivot pin that is supported inside a housing. This pivot pin is surrounded by an elastomeric body in the housing. A characteristic property of molecular joints or molecular journals is that they dampen movements that are introduced via the pivot pin or the suspension strut by means of the elastomeric body, thereby making the term of molecular bearing an appropriate one. However, since molecular bearings, or molecular joints, also enable a relative movements of the components connected to each other by way of the elastomeric body, they can also be referred to as molecular joints. The elastomeric body can be connected to the housing and/or the pivot pin by means of vulcanization. In addition, configurations are known in which the elastomeric body does not have a firm adhesive connection to the housing and/or the pivot pin. Such molecular joints are used in wheel suspensions of a wide variety of motor vehicles due to their damping and vibration-insulating properties. The suspension strut disclosed in the published prior art mentioned last is used as a longitudinal control arm between a vehicle axle of a commercial vehicle and the automotive body. Moreover the axial joint is fastened to the automotive body. Axle concepts known so far and used for guiding rigid axles comprise molecular joints on the axle side, in which the pivot pins are oriented transversely to the longitudinal center line of the suspension strut. Such axle concepts, however, require significant installation space in the region of the vehicle axle. In addition, as a result of the installation of the molecular joints of the suspension struts at a distance from the geometric axle center of the rigid axle, torque is created at the suspension struts, which must be compensated for during operation. The most frequently used suspension struts additionally have a molecular joint on either side, which makes the production thereof overall complex and cost-intensive.

### SUMMARY OF THE INVENTION

The underlying object of the invention is to develop a rigid axle for a commercial vehicle, the suspension struts of which enable a low overall height, and which additionally is simple and cost-effective to produce.

A rigid axle for a commercial vehicle, comprising two individual suspension struts that define a triangle in a common plane, at the ends of which a joint each being connected to the automotive body and to the vehicle axle, was refined according to the invention in that at least on the axle side an axial pin is inserted into the suspension struts for connecting the suspension struts to the vehicle axle.

The particular advantage of the solution according to the invention is to be seen in that a smaller installation space is required than was the case with solutions having molecular joints for connecting the vehicle axle to the suspension struts. The flanges required for connecting the suspension struts to the vehicle axle can likewise be reduced in their overall height. There is even the possibility to integrate the fastening points for the suspension struts directly in the vehicle axle. Such a configuration cannot be implemented with molecular joints. By reducing the overall height in the region of the vehicle axle, for example, it is possible with the solution according to the invention to lay the vehicle even lower overall. As a result of the simplification of suspension struts according to the invention for a rigid axle, furthermore uniform components and subassemblies can be used for different applications. In this way, a modular system can be created, which enables an orientation toward few standard components. Consequently, in addition to the considerable simplification, a critical cost advantage also results.

A first configuration of the invention provides that the point of intersection of the geometric longitudinal center lines of the suspension struts in their neutral positions is located in the direct vicinity of the geometric axle center or the center line of the vehicle axle. Through such a configuration of the connection of the suspension struts according to the invention to a rigid axle, interfering torque can be avoided, or at least significantly reduced, on the components of the suspension when operating the motor vehicle, which means that the overall mechanical load of the suspension struts is reduced. In the process, the goal is to provide the connection of the suspension struts as close as possible to the axle center or the center line of the vehicle axle, whereby this is also to be interpreted as an arrangement that is disposed slightly in front of or behind this intersecting point in the vehicle longitudinal direction.

The same advantage as that which was previously mentioned already in connection with point of intersection of the geometric longitudinal center lines can be achieved if the point of intersection of the geometric longitudinal center lines of the suspension struts in the neutral positions thereof is located perpendicularly above the geometric axle center or the center line of the vehicle axle. These constructions mentioned above in each case bring the design position of the suspension struts, and particularly the attachment of their axle-side joints, as close as possible to the axle center or the center line of the vehicle axle.

According to another construction variant of the invention, the center of the joint ball of the axial pin of the axial joint of the suspension struts formed therewith is located in a plane extending perpendicularly through the geometric center line of the vehicle axle. In such a configuration, it is true that the geometric point of intersection of the longitudinal center lines of the suspension struts is disposed behind the rigid axle of the motor vehicle. However this provides the advantage that a pitching motion, which is to say a pivoting of the automotive body about the lateral vehicle axis, can be largely prevented or at least noticeably reduced. A variant construction that is within the range of this proposed solution may have a slight distance of the center of the joint ball of the axial pin to the plane extending perpendicularly through the geometric center line of the vehicle axle.

Advantageously, the suspension struts defining a geometric triangle with each other have an angle between 45° and 60°, which they form together. In this region of the arrangement of the suspension struts to each other, they form a triangular control arm, which allows both optimal longitudinal and lateral force support of the rigid axle of the commercial vehicle. Such axle location saves additional complex components, such as Panhard rods.

With regard to a simplification of the axle location of the entire rigid axle according to the invention for a commercial vehicle, in keeping with a particularly advantageous refinement of the invention it is also proposed that the suspension struts have a rod-shaped or tubular body that overall is cast and has a joint housing, which is configured on at least one of the ends of the body. The production of such suspension struts is significantly simplified compared to the known forged configurations. In addition, such a design according to the invention can considerably reduce the number of individual components. In a particularly advantageous manner, a spherical graphite cast is suited for the casting. In addition to optimum strength, this material also has lubricating properties, whereby it becomes possible to directly integrally mold the joint housing or housings on the rod-shaped or tubular body of the suspension strut.

In line with this concept, it is also proposed that the axial pins be directly inserted into the parts of the suspension struts configured as joint housings. In this way, the axial pins are also directly supported in the joint housing. Here, the previously mentioned properties of the spherical graphite cast play a key role, enabling lubrication of the bearing point to a limited extent. In this way, a very robust and simply configured support of the axial pin was created, which additionally is implemented to have extremely low friction.

Depending on the requirements that are placed on the suspension struts of the inventive rigid axle, however, it may also be desirable or necessary to insert at least one bearing shell made of plastic or metal into the joint housing in order to accommodate a joint ball of the axial pin.

Furthermore, it is possible both with the direct support of the axial pin in the joint housing of the suspension strut, and with the support of the axial pin inside a bearing shell, to additionally introduce at least one damping element in the joint housing. This damping element, which preferably consists of an elastomeric material, such as rubber, is suited to absorb vibrations of the individual parts of such a suspension strut, which can move relative to each other.

Each of the above-described configurations of the support of the axial pin can furthermore be improved with respect to the friction properties thereof by a gliding layer, which is provided in the joint housing or in the bearing shell.

A further reaching concept of the invention is that the suspension struts forming a triangular control arm as well as additional longitudinal control arms (which on the one hand deviate from the height of the suspension struts and on the other are fastened to the vehicle axle and the automotive body) are fastened to the vehicle axle by way of a joint configured as an axial joint. In this way, the principle according to the invention can not only be applied to the above configuration of the suspension struts in the spirit of a triangular control arm arrangement, but it can also be applied to other control arms for guiding the rigid axle of a commercial vehicle.

In addition to the above-mentioned configuration comprising one axial joint each on the suspension strut, solutions in which one axial joint each is provided on both sides of the suspension struts are also within the meaning of the invention.

### BRIEF DESCRIPTION OF THE DRAWINGS

The invention will be described in more detail below based on the appended figures. The examples of embodiments shown do not represent any restriction to the illustrated variants, but are only used to explain the principle of the invention. To this end, identical or similar components are denoted with the same reference numbers. In order to be able to illustrate the operating principle according to the invention, the figures show only highly simplified representative illustrations, in which components that are not essential for the invention have been eliminated. However, this does not mean that such components are not present in a solution according to the invention, wherein:

FIG. 1: is a top view of a rigid axle for a commercial vehicle;

FIG. 2: is the view according to the arrow II from FIG. 1 onto the rigid axle shown in FIG. 1;

FIG. 3: is a view of the rigid axle according to the arrow III from FIG. 2, which is to say from the bottom of the vehicle;

FIG. 4: is a schematically simplified first possible arrangement of a suspension strut on a rigid axle according to the ivnention;

FIG. 5: is another possibility of the arrangement of the suspension strut on a rigid axle according to the invention; and

FIG. 6: are sections and a cut view of a suspension strut for use in a rigid axle according to the invention as a component illustration.

### DETAILED DESCRIPTION OF THE PREFERRED EMBODIMENTS

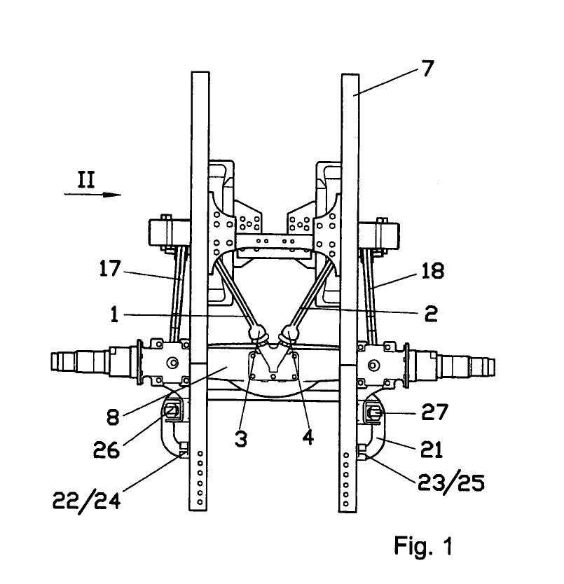

The top view illustrated in FIG. 1 of a rigid axle from the top of the vehicle, shows two suspension struts 1 and 2, which together define a triangle in a common plane. The suspension struts 1 and 2 each have a joint at each of the ends thereof. FIG. 1 shows the joints 3 and 4 of the suspension struts 1 and 2 on the axle side. The opposing joints 5 and 6 of the suspension struts 1 and 2, these joints being mounted on the automotive body 7, are not shown in this illustration. In this example, the automotive body 7 is configured as an enclosed frame (chassis). The axial pins of the joints 3 and 4 of the suspension struts 1 and 2 are screwed into a flange mounted on the vehicle axle 8. Beneath the vehicle axle 8, furthermore two longitudinal control arms 17 and 18 are mounted at a height that deviates from the fastening of the suspension struts 1 and 2, wherein these control arms are connected both the vehicle axle and to the automotive body 7. A stabilizing bar 21 is provided to compensate for rolling motions.

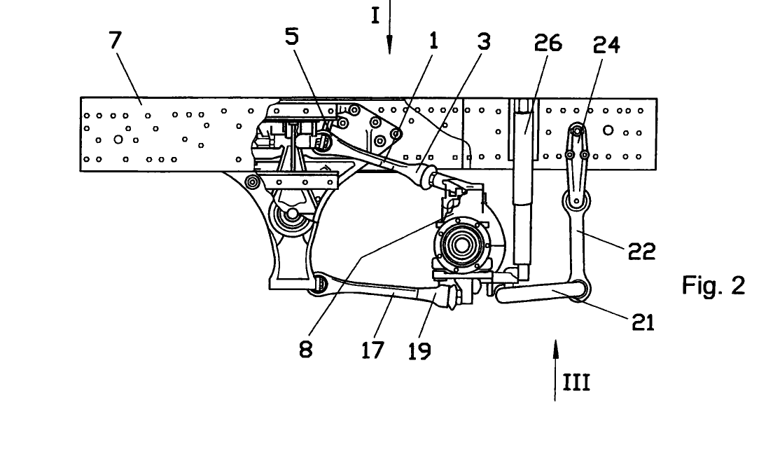

The fastening of the suspension struts 1 and 2 and of the longitudinal control arms 17 and 18 to the vehicle axle 8, deviating from one another in terms of height, emerges more distinctly from the illustration in FIG. 2. In this figure, also an arrow I is shown, which indicates the view of the rigid axle according to the illustration from FIG. 1. The axial joint 3 of the suspension strut 1 visible here is directly screwed into a flange that is fastened on the vehicle axle 8. On the opposing side of the suspension strut 1, the strut has a molecular joint 5, which is connected to the automotive body 7. In order to improve the driving properties of the rigid axle shown in FIG. 2, it also has a shock absorber 26. Furthermore, a stabilizing bar 21 is guided along beneath the vehicle 8, which is connected to the automotive body 7 by way of a connecting control arm 22 and a holder 24. In the embodiment shown, the longitudinal control arm also has an axial joint 19 beneath the vehicle axle 8 on the axle side. This axial joint 19 is screwed into a suitable flange of the vehicle axle 8. On the side opposite the axial joint 19, the control arm 17 has a molecular joint, which is not described in more detail.

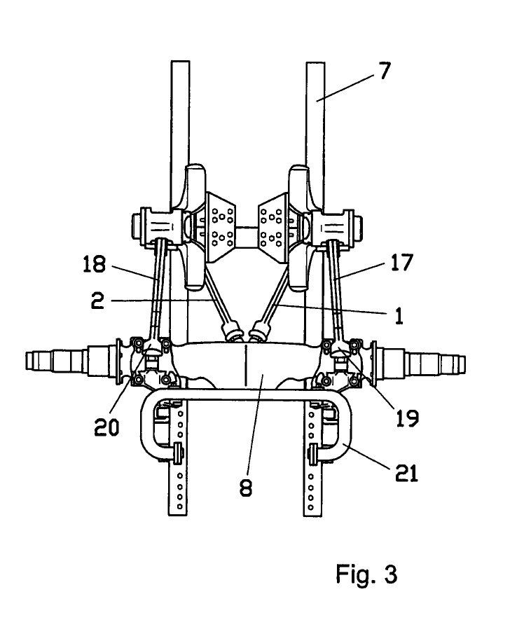

The view of the rigid axle from FIG. 3 corresponds to the direction of the arrow III in FIG. 2. It clarifies again the arrangement of the stabilizing bar 21. This bar connects the left part, viewed in the vehicle direction, to the right part of the automotive body 7 configured as a chassis. The stabilizing bar compensates for distortions of the axle, as those that occur, for example, when traveling in a curve.

FIG. 3 further shows the attachment of the longitudinal control arms 17 and 18 by way of an axial joint each 19, or 20, to a flange each of the vehicle axle 8. Since the longitudinal control arms 17 and 18 are mounted beneath the vehicle axle 8, and the suspension struts 1 and 2 are mounted above the vehicle axle 8, the recognizability of the suspension struts 1 and 2 is restricted in the view from FIG. 3.

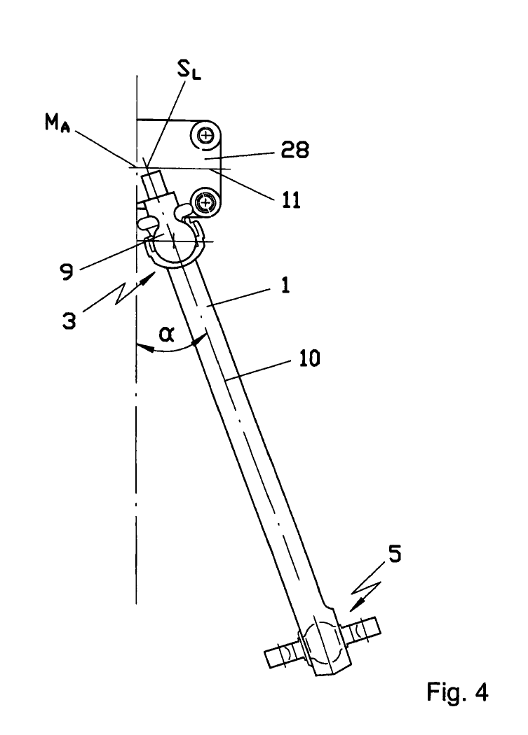

Finally, FIG. 4 shows a first possible arrangement of the suspension strut 1 on the vehicle axle 8. The suspension strut 1 in this example has a joint 3, which is configured as an axial joint. On the side opposite the axial joint 3, the suspension strut 1 has a molecular joint 5. The axial pin 9 of the axial joint 3 of the suspension strut 1 in the position shown here, which is not deflected, has a longitudinal center line, which runs coaxially to the longitudinal center line 10 of the suspension strut 1. The axial pin 9, however, can also be disposed in the neutral installation position thereof at an angle with respect to the longitudinal center line 10.

The particularity of the attachment of the suspension strut 1 in FIG. 4 is that fastening the axial pin 9 to a flange 28 of the vehicle axle 8 is carried out such the extension of the longitudinal center line 10 of the suspension strut above the axle center M_{A} has a point of intersection S_{L} with the center line 11 of the vehicle axle 8.

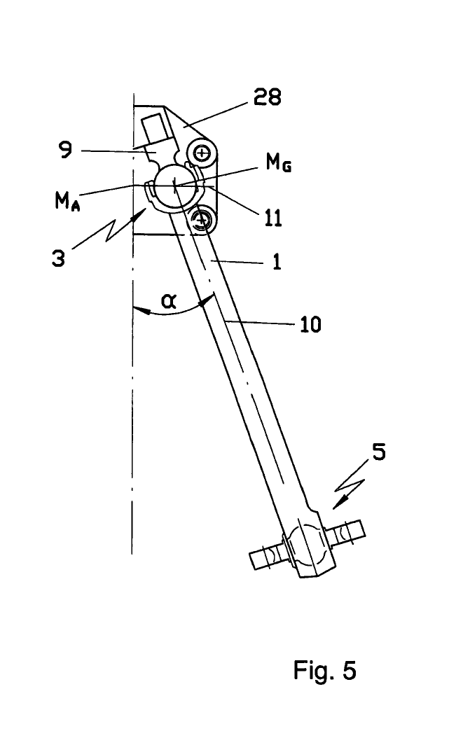

Such fastening of the suspension strut 1 to the vehicle axle 8 achieves the same optimal guidance of the vehicle axle by way of the suspension struts, as that which is also possible with another variant of the attachment of the suspension strut 1 to the vehicle axle 8 according to FIG. 5. Here the suspension strut 1 is fastened to the vehicle axle 8 such that the joint ball center M_{G} of the axial pin 9 configured as a ball pin 9 directly coincides with the center line 11 of the vehicle axle 8 and, projected onto a common plane, is located in the direct vicinity of the geometric axle center M_{A}. The attachment of the axial pin 9 again is carried out to the flange 28 of the vehicle axle 8. In FIGS. 4 and 5, an angle α is provided for illustrating the straddled arrangement of the suspension struts 1 and 2, this angle preferably ranging between 45° and 60°. In the example of the embodiment α=50°. For simplification reasons, in the illustrations according to FIGS. 4 and 5 in each case only one of the two symmetrically disposed suspension struts 1 and 2 is shown.

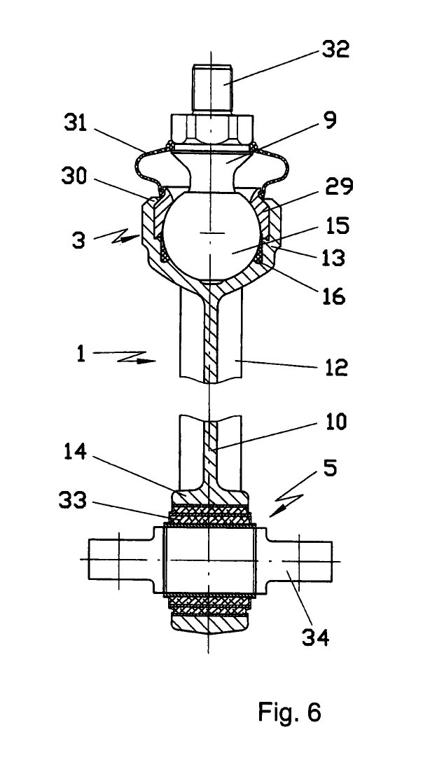

The possible design of a particularly preferred embodiment of a suspension strut 1 for use in a rigid axle according to the invention is apparent from FIG. 6. It should be noted that the suspension strut 1 overall is made of a one-piece cast component, whereby spherical graphite material comes into use. At the ends of the suspension strut 1, joint housings 13 or 14 are integrally molded on after the rod-shaped body 12. In this way, the suspension strut 1, comprising the rod-shaped body 12 and the joint housings 13 and 14, can be produced as a single-piece component in one casting operation. The example of the suspension strut 1 shown in a simplified section view in FIG. 6 allows the design of the joints 3 and 5 to be explained in more detail. The joint 3 is constructed as an axial joint. It has an axial pin 9. This axial pin 9, having a joint ball 15, is inserted with the joint ball 15 directly into a suitable recess of the joint housing 13 of the suspension strut 1 such that a bearing shell can be dispensed with. In order to dampen vibrations and improve the elastic properties, a recess is provided in the joint housing 13, a damping element 16 being inserted in this recess. In order to close the housing opening of the joint housing 13, a locking ring 29 is provided, which with the lateral inside surface thereof rests directly against the joint ball 15 and thereby likewise forms a metal abutment for the joint ball 15. On the side opposite the joint ball 15, the locking ring 29 has a shoulder, against which a conversion segment 30 of the joint housing 13 rests. The deformation of this conversion segment 30 is carried out after installation of the ball joint components. The locking ring 29, however, can also be fixed in the housing 13 in a different manner. A screw assembly should be mentioned here only by way of example. Furthermore, the locking ring 28 with a groove, which is present on the lateral outside surface thereof outside the joint housing 13, is used for the contact of an edge of a bellows seal 31 sealing the inner joint components. The second edge of the bellows seal 31 rests directly against the axial pin 9. For fixation purposes and to improve the sealing effect, both edge sections of the bellows seal 31 are attached to the component by means of tension rings, which are not described in detail. In order to connect the axial pin 9 to a connecting flange 28 of the vehicle axle 8, the axial pin 9 at the end has a connecting thread 32. On the side opposite the axial joint 3, a molecular joint 5 is provided on the suspension strut 1. This molecular joint is characterized by a nearly circular cylindrical housing 14. A through-hole introduced into the joint housing 14 is inserted into an elastomeric body 33. This elastomeric body 33, which in the present example has multiple layers and is provided with intermediate layers to improve the support properties, receives a connecting pin 34, which in this example was configured as a cylinder pin. The key in the molecular joint shown is that the connecting pin 34 has a longitudinal center line, which runs transversely to the longitudinal center line 10 of the suspension strut 1, as is characteristic for molecular joints and the fastening thereof to vehicle axles, or to the automotive body.

### LIST OF REFERENCE NUMERALS

1 Suspension strut
2 Suspension strut
3 Joint
4 Joint
5 Joint
6 Joint
7 Automotive body (chassis)
8 Vehicle axle
9 Axial pin
10 Longitudinal center line of the suspension strut
11 Center line of the vehicle axle
12 Rod-shaped or tubular body
13 Joint housing
14 Joint housing
15 Joint ball
16 Damping element
17 Longitudinal control arm
18 Longitudinal control arm
19 Axial joint
20 Axial joint
21 Stabilizing bar
22 Connecting control arm
23 Connecting control arm
24 Holder
25 Holder
26 Shock absorber
27 Shock absorber
28 Flange
29 Locking ring
30 Conversion segment
31 Bellows seal
32 Connecting thread
33 Elastomeric body
34 Connecting pin

1-11. (canceled)

12. A rigid axle for a commercial vehicle, the axle comprising:
individual two suspension struts (1, 2) that define a triangle in a common plane, and each end of the two suspension struts (1, 2) having a joint (3, 4, 5, 6) that is connected to one of an automotive body (7) and a vehicle axle (8) of the commercial vehicle, and
an axial pin (9), at least on an axle side of each of the two suspension struts (1, 2), being inserted in each of the suspension struts (1, 2) for connecting the suspension struts (1, 2) to the vehicle axle (8).

13. The rigid axle according to claim 12, wherein a point of intersection (S_{L}) of geometric longitudinal center lines (10) of the two suspension struts (1, 2), in neutral positions thereof, is located in a direct vicinity of one of a geometric axle center (M_{A}) and a center line (11) of the vehicle axle (8).

14. The rigid axle according to claim 12, wherein a point of intersection (S_{L}) of geometric longitudinal center lines (10) of the two suspension struts (1, 2), in neutral positions thereof, is located one of perpendicularly above one of a geometric axle center (M_{A}) and a center line (11) of the vehicle axle (8).

15. The rigid axle according to claim 12, wherein a center of a joint ball (M_{G}) of the axial pin (9) of the axial joint (3, 4) of the suspension struts (1, 2) formed therewith is located in a plane extending perpendicularly along a geometric center line (11) of the vehicle axle (8).

16. The rigid axle according to any claim 12, wherein the two suspension struts (1, 2) defining a geometric triangle with each other together form an angle (a) between 45° and 60°.

17. The rigid axle according to claim 12, wherein the two suspension struts (1, 2) have either a rod-shaped body or a tubular body (12) that overall is cast and has a joint housing (13, 14), which is configured on at least one of the ends thereof.

18. The rigid axle according to claim 17, wherein the axial pin (9) is directly inserted into parts of the suspension struts (1, 2) configured as a joint housing (13).

19. The rigid axle according to claim 17, wherein at least one bearing shell, made of either plastic or metal, is inserted into the joint housing (13) for receiving a joint ball (15) of the axial pin (9).

20. The rigid axle according to claim 17, wherein at least one damping element (16), made of an elastomeric material, is inserted into the joint housing (13).

21. The rigid axle according to claim 17, wherein at least one gliding layer is present on either the joint housing (13) or on a bearing shell.

22. The rigid axle according to claim 12, wherein the two suspension struts (1, 2) form a triangular control arm, and longitudinal control arms (17,18), which deviate from a height position of the two suspension struts (1, 2) and are fastened to the vehicle axle (8) and the automotive body (7), are fastened to the vehicle axle (8) by a joint configured as an axial joint (19, 20).

23. A rigid axle for a commercial vehicle, the axle (8) comprising:
first and second suspension struts (1, 2), each of the first and the second suspension struts (1, 2) having a longitudinal axis (10), a first end with a socket housing (13) and an opposed second end with a cylindrical housing (14);
the socket housing (13) of each of the first and the second suspension struts (1, 2) receiving a ball (15) of a bearing pin (9) for forming a ball joint (3, 4), the bearing pin (9) of each of the ball joints (3, 4) being rigidly fixed to a flange (28), which is fixed to the axle (8);
the cylindrical housing (14), of each of the first and the second suspension struts (1, 2), receiving a connecting pin (34) for forming an elastomeric joint (5), the connecting pin (34) being rigidly connected to an automotive chassis (7) having a longitudinal axis; and
the bearing pin (9) of each of the ball joints (3, 4) are fixed to the vehicle axle (8) and the connecting pin (34) of each of the elastomeric joints (5) are connected to the automotive chassis (7) such that the longitudinal axis (10) of the first suspension strut (1) and the longitudinal axis (10) of the second suspension strut (2) bisect each other approximately at a point located directly vertically above an axial center of the vehicle axle (8) and define a triangle in a common plane.
